(19) United States
(12) Patent Application Publication
(10) Pub. No.: US 2009/0128539 A1
(43) Pub. Date: May 21, 2009

(54) Plasma display device and driving method thereof

(76) Inventors: Suk-Ki Kim, Suwon-si (KR); Jeong-Hoon Kim, Suwon-si (KR); Jung-Soo An, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,815

(22) Filed: Nov. 5, 2008

(30) Foreign Application Priority Data
Nov. 19, 2007 (KR) 10-2007-0117982

(51) Int. Cl. G09G 5/00

(52) U.S. Cl. 345/212

(57) ABSTRACT

A scan electrode driver includes a scan integrated circuit including first and second control signal input terminals, a data input terminal, first and second voltage terminals and a plurality of output terminals, and a logic element. A voltage of the plurality of output terminals may be a voltage of one the plurality of voltage terminals at least based on a level of a control signal transmitted to the first control signal input terminal. The logic element may be adapted to perform an operation on the control signal to generate a second control signal to be applied to the second control signal input terminal. The scan integrated circuit may establish a voltage of the plurality of output terminals to be a voltage of the first or second voltage terminal based on a level of the control signal.

### BACKGROUND OF THE INVENTION

1. Field of the Invention

Embodiments relate to a plasma display device and a driving method thereof.

2. Description of the Related Art

A plasma display device is a display device that uses a plasma display panel (PDP) for displaying characters or images using plasma that is generated by a gas discharge. In the PDP, a plurality of cells are generally disposed in a matrix format. The plasma display device divides a frame into a plurality of subfields that may be driven to display an image.

The plasma display device may be divided into a plurality of subfields each having a weight value for driving. In an address period of each subfield, a cell to be turned on or a cell not to be turned on is selected by sequentially applying a scan pulse to a plurality of scan electrodes. In a sustain period, a sustain discharge is performed in a cell to be turned on in order to actually display an image by alternately applying a high level voltage and a low level voltage of a sustain discharge pulse to an electrode for performing a sustain discharge.

The plasma display device generally uses a scan integrated circuit (IC) for sequentially applying scan pulses to the plurality of scan electrodes during the address period. In general, a control signal is input to the scan IC to control an operation of the scan IC. However, when the control signal is unstable, the scan IC may have an error.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

Embodiments are therefore directed to a plasma display device and a driving method for a plasma display device, which substantially overcome one or more of the problems due to the limitations and disadvantages of the related art.

It is therefore a feature of an embodiment of the present invention to provide plasma display devices that are capable of preventing and/or reducing an erroneous operation of a scan integrated circuit.

It is therefore a separate feature of an embodiment of the present invention to provide methods of driving a plasma display device that is capable of preventing and/or reducing an erroneous operation of a scan integrated circuit.

It is therefore a separate feature of an embodiment of the present invention to provide plasma display devices in which an erroneous operation of a scan integrated circuit caused by, e.g., delays of a control signal output from a controller and/or a generated control signal may be prevented and/or reduced.

It is therefore a separate feature of an embodiment of the present invention to provide methods of driving a plasma display device in which an erroneous operation of a scan integrated circuit caused by, e.g., delays of a control signal output from a controller and/or a generated control signal may be prevented and/or reduced.

It is therefore a separate feature of an embodiment of the present invention to provide plasma display devices employing a controller that may be more simply designed, as compared to conventional controllers, because, e.g., the controller is not required to generate another control signal.

At least one of the above and other features and advantages of the present invention may be realized by providing a scan electrode driver employable to drive a plurality of scan electrodes and to receive a control signal, the scan electrode driver including at least one scan integrated circuit including a first control signal input terminal, a second control signal input terminal, a data input terminal, a first voltage terminal, a second voltage terminal and a plurality of output terminals respectively connected to the plurality of scan electrodes, and a logic element adapted to perform an operation on the control signal to generate a second control signal to be applied to the second control signal input terminal, wherein the scan integrated circuit is adapted to establish a voltage of the plurality of output terminals to be a voltage of the first voltage terminal or a voltage of the second voltage terminal at least based on a level of the control signal transmitted to the first control signal input terminal thereof, and the control signal and the second control signal have a first level or a second level.

The logic element may be an inverter.

When the control signal is at the first level and the scan integrated circuit receives a first data pulse of a third level at the data input terminal thereof, the scan integrated circuit may be adapted to sequentially output the voltage of the second voltage terminal to selected ones of the plurality of scan electrodes based on the first data pulse and to output the voltage of the first voltage terminal to the ones of the plurality of scan electrodes to which the voltage of the second voltage terminal is not applied.

When the control signal is at the first level and the scan integrated circuit receives a second data pulse of a fourth level at the data input terminal thereof, the scan integrated circuit may be adapted to output the voltage of the first voltage terminal to the plurality of scan electrodes.

When the control signal is at the second level, the scan integrated circuit may be adapted to output a voltage of the second voltage terminal to the plurality of scan electrodes.

The scan electrode driver may include only one scan integrated circuit.

The at least one scan integrated circuit may include a first scan integrated circuit and a second scan integrated circuit and the control signal includes a first control signal and a third control signal, the first scan integrated circuit may be adapted to receive the first control signal as at the first control signal input terminal thereof, and the second scan integrated circuit may be adapted to receive the third control signal at the first control signal input terminal thereof, the first, second and third control signals have the first level or the second level.

The logic element may be adapted to perform an operation on the first control signal and the third control signal to generate the second control signal, output terminals of the first scan electrode driver may be respectively connected to respective ones of the plurality of scan electrodes belonging to a first group of scan electrodes, output terminals of the second scan electrode driver may be respectively connected to respective ones of the plurality of scan electrodes belonging to a second group of scan electrodes, the first scan integrated circuit may be adapted to apply the voltage of the first voltage terminal or the voltage of the second voltage terminal to the scan electrodes of the first group based on a level of at least one of the first control signal and the second control signal, and the second scan integrated circuit may be adapted to apply the voltage of the first voltage terminal of the voltage of the second voltage terminal to the scan electrodes of the second group based on a level of at least one of the third control signal and the second control signal.

The logic element may be a NAND gate.

The second control signal may be at the second level when the first and third control signals are at the first level, the second control signal may be at the second level when one of the first and third control signals is at the first level and the other of the first and third control signals is at the second level, and the second control signal may be at the first level when the first and third control signals are at the second level.

When the first control signal is at the first level, the third control signal is at the second level and the first scan integrated circuit receives a first data pulse of a third level at the data input terminal thereof, the first scan integrated circuit may be adapted to sequentially output the voltage of the second voltage terminal to the plurality of scan electrodes of the first group based on the first data pulse, and the second scan integrated circuit may be adapted to output the voltage of the first voltage terminal to the plurality of scan electrodes of the second group.

When the first control signal is at the second level, the third control signal is at the first level and the second scan integrated circuit receives a second data pulse of a third level at the data input terminal thereof, the second scan integrated circuit may be adapted to sequentially output the voltage of the second voltage terminal to the plurality of scan electrodes of the second group based on the second data pulse, and the first scan integrated circuit may be adapted to output the voltage of the first voltage terminal to the plurality of scan electrodes of the first group.

When the first control signal is at the first level, the third control signal is at the first level, the first scan integrated circuit receives a third data pulse of a fourth level at the data input terminal thereof, and the second scan integrated circuit receives the third data pulse of the fourth level, the first scan integrated circuit may be adapted to output the voltage of the first voltage terminal to the plurality of scan electrodes of the first group, and the second scan integrated circuit may be adapted to output the voltage of the first voltage terminal to the plurality of scan electrodes of the second group.

When the first control signal is at the second level and the third control signal is at the second level, the first scan integrated circuit may be adapted to output the voltage of the second voltage to the plurality of scan electrodes of the first group, and the second scan integrated circuit may be adapted to output the voltage of the second voltage terminal to the plurality of scan electrodes of the second group.

The first level may be a low level, and the second level may be a high level.

At least one of the above and other features and advantages of the present invention may be separately realized by providing a driving method for a plurality of scan electrodes of a plasma display device using a scan electrode driver including at least one scan integrated circuit adapted to transmit a voltage to the plurality of scan electrodes, the driving method including transmitting a control signal to the scan integrated circuit, generating a second control signal based on the control signal, and transmitting, from the scan integrated circuit, a voltage to the plurality of scan electrodes based on the control signal and the second control signal.

Generating the second control signal may include generating the second control signal by performing a logic operation, the control signal being input to the logic operation.

The logic operation may be one of an inversion operation or a NAND operation.

The at least one scan integrated circuit may include a first scan integrated circuit adapted to transmit a voltage to respective ones of the plurality of scan electrodes belonging to a first group and a second scan integrated circuit adapted to transmit a voltage to respective ones of the plurality of scan electrodes belonging to a second group, and the control signal may include a first control signal and a third control signal, where transmitting may include transmitting the first control signal to the first scan integrated circuit, and transmitting the third control signal to the second scan integrated circuit, and generating may include generating, within the scan electrode driver, the second control signal based on the first control signal and the third control signal.

Generating may include generating the second control signal using a NAND operation, the first control signal and the third control signal being input to the NAND operation.

### BRIEF DESCRIPTION OF THE DRAWINGS

The above and other features and advantages will become more apparent to those of ordinary skill in the art by describing exemplary embodiments with reference to the attached drawings, in which:

FIG. 1 illustrates a diagram of a plasma display device according to an exemplary embodiment of the present invention;

FIG. 2 illustrates a schematic diagram of an exemplary embodiment of the scan electrode driver shown in FIG. 1 according to a first exemplary embodiment of the present invention;

FIG. 3 illustrates a schematic circuit diagram of a pair of transistors in the exemplary scan integrated circuit shown in FIG. 2;

FIG. 4 illustrates a diagram of exemplary driving waveforms employable to drive the plasma display device shown in FIG. 1 according to a first exemplary embodiment of the present invention;

FIG. 5 illustrates a schematic diagram of another exemplary embodiment of a scan electrode driver according to a second exemplary embodiment of the present invention; and

FIG. 6 illustrates a diagram of exemplary driving waveforms employable to drive the plasma display device shown in FIG. 1 according to a second exemplary embodiment of the present invention.

### DETAILED DESCRIPTION OF THE INVENTION

Korean Patent Application No. 10-2007-0117982, filed on Nov. 19, 2007, in the Korean Intellectual Property Office, and entitled: “Plasma Display Device and Driving Method Thereof,” is incorporated by reference herein in its entirety.

Exemplary embodiments will now be described more fully hereinafter with reference to the accompanying drawings, in which exemplary embodiments of the invention are illustrated. One or more aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

Like reference numerals refer to like elements throughout the specification.

As used herein, the expressions “at least one,” “one or more,” and “and/or” are open-ended expressions that are both conjunctive and disjunctive in operation.

As used herein, unless specified otherwise, the terms “a” and “an” are open terms that may be used in conjunction with singular items or with plural items.

Throughout this specification and the claims that follow, when it is described that an element is “connected” or “coupled” to another element, the element may be “directly connected” or “directly coupled” to the other element or “electrically connected” or “electrically coupled” to the other element through a third element. In addition, unless explicitly described to the contrary, the word “comprise” and variations such as “comprises” or “comprising” will be understood to imply the inclusion of stated elements but not the exclusion of any other elements.

In the following description, it will be understood that a wall charge is a charge formed close to each electrode on the wall of a cell, e.g., a dielectric layer. Although the wall charges may not actually touch the electrodes, the wall charges will be described as being “formed” or “accumulated” on the electrode. Also, a wall voltage is a potential difference formed at the wall of a cell by wall charges. A weak discharge is a discharge that is weaker than a sustain discharge in a sustain period and an address discharge in an address period.

A plasma display device according to an exemplary embodiment of the present invention and a driving method thereof will now be described.

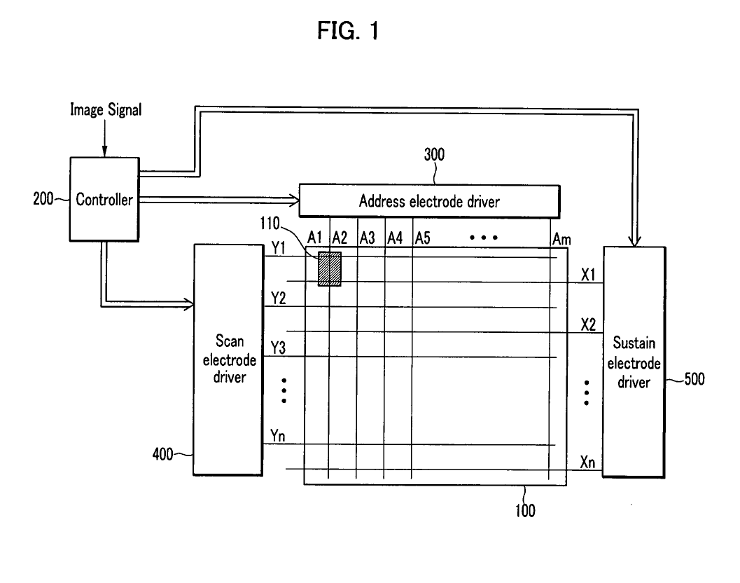

FIG. 1 illustrates a diagram of a plasma display device according to an exemplary embodiment of the present invention.

As shown in FIG. 1, the plasma display device according to the exemplary embodiment of the present invention may include a plasma display panel (PDP) 100, a controller 200, an address electrode driver 300, a scan electrode driver 400, and a sustain electrode driver 500.

The PDP 100 may include a plurality of address electrodes A1 to Am (hereinafter referred to as “A electrodes”) extending in a column direction, and pluralities of sustain and scan electrodes X1 to Xn and Y1 to Yn (hereinafter respectively referred to as “X electrodes” and “Y electrodes”) extending in a row direction, in pairs. In general, the X electrodes X1 to Xn may be formed corresponding to the Y electrodes Y1 to Yn, respectively.

The X electrodes and Y electrodes may perform a display operation to display an image during a sustain period. The Y electrodes Y1 to Yn and the X electrodes X1 to Xn may be disposed to cross the A electrodes A1 to Am. Discharge spaces at crossing regions of the A electrodes A1 to Am and the X and Y electrodes X1 to Xn and Y1 to Yn may form discharge cells 110. The above described structure of the PDP is only an example. One or more aspects of the invention may be applied to panels having different structures and to which driving waveform(s) to be described later may be applied.

The controller 200 may receive an external video signal, and may output an A electrode driving control signal, an X electrode driving control signal, and a Y electrode driving control signal. The controller 200 may divide one frame into a plurality of subfields. The controller 200 may drive the subfields. Each subfield may include a reset period, an address period, and a sustain period with respect to time.

The address electrode driver 300 may receive the A electrode driving control signal from the controller 200. The address electrode driver 300 may apply a display data signal for selecting a desired discharge cell(s) to the respective A electrode(s).

The scan electrode driver 400 may receive the Y electrode driving control signal from the controller 200 and may apply a driving voltage to the respective Y electrode.

The sustain electrode driver 500 may receive the X electrode driving control signal from the controller 200 and may apply the driving voltage to the respective X electrode.

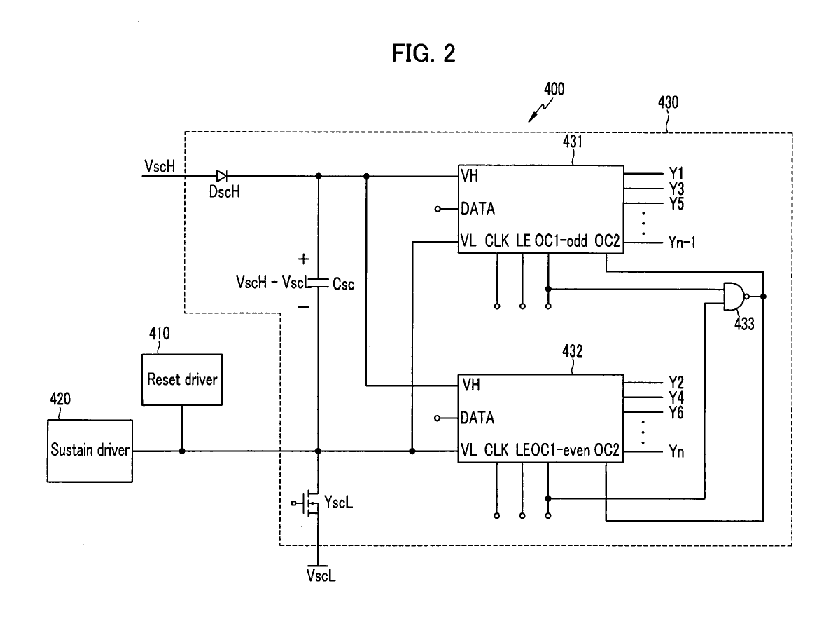

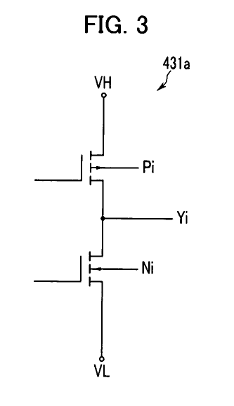

FIG. 2 illustrates a schematic diagram of an exemplary embodiment of the scan electrode driver 400 shown in FIG. 1 according to a first exemplary embodiment of the present invention. FIG. 3 illustrates a schematic circuit diagram of a pair of transistors in the exemplary scan integrated circuit(s) 431, 432 shown in FIG. 2. In FIG. 3, for better understanding and ease of description, only a pair of transistors connected to an ith Y electrode is illustrated.

As shown in FIG. 2, the scan electrode driver 400 may include a reset driver 410, a sustain driver 420, and a scan driver 430. The scan driver 430 may include scan integrated circuits (hereinafter referred to as “scan ICs”) 431 and 432, a capacitor Csc, a diode DscH, a transistor YscL, and a NAND gate 433.

In the exemplary embodiment illustrated in FIG. 2, the plurality of Y electrodes Y1 to Yn are grouped as two groups Yodd and Yeven. In such embodiments, the first group Yodd may include odd-numbered Y electrodes among the plurality of Y electrodes, and the second group Yeven may include even-numbered Y electrodes among the plurality of Y electrodes.

A plurality of output terminals of the scan IC 431 may be respectively connected to the Y electrodes Y1, Y3, . . . , Yn−1 of the first group Yodd, and a plurality of output terminals of the scan IC 432 may be respectively connected to the Y electrodes Y2, Y4, . . . , Yn of the second group Yeven. It is assumed in FIG. 2 that n denotes an even number. Embodiments are not limited thereto. In the exemplary embodiment illustrated in FIG. 2, a single scan IC 431, 432 is respectively illustrated for each of the first and second groups Yodd, Yeven. For example, in embodiments, a plurality of scan ICs may be used for one or more of the groups, e.g., when a number of output terminals of the respective scan ICs is less than a number of Y electrodes for a group(s).

The scan ICs 431, 432 may each include a high voltage terminal VH and a low voltage terminal VL. Each of the scan ICs 431, 432 may be driven by control signals OC1_odd, OC1_even, and OC2, a clock signal CLK, a data signal DATA, and a latch signal LE. In the exemplary embodiment shown in FIG. 2, the NAND gate 433 may perform a NAND operation for two control signals OC1_odd and OC1_even and may output the control signal OC2. The control signals OC1_odd and OC1_even may be input to the scan ICs 431 and 432.

In the exemplary embodiment illustrated in FIG. 2, because the control signal OC2 is generated by the control signals OC1_odd and OC1_even that may be output from the controller 200 shown in FIG. 1, an erroneous operation of the scan ICs 431 and 432 caused by delays of the control signal OC2 and the control signals OC1_odd and OC1_even may be prevented and/or reduced. In addition, because the controller 200 is not required to generate the control signal OC2, the controller 200 may be more simply designed.

Referring to FIG. 3, the scan ICs 431, 432 may include pairs of transistors 431a. The pairs of transistors 431a may be respectively connected to the plurality of output terminals, e.g., terminals thereof connected to the corresponding ones of the Y electrodes, of the scan ICs 431, 432. More particularly, e.g., the pairs of transistors 431a may include a PMOS transistor Pi connected between the high voltage terminal VH and an output terminal Yi and an NMOS transistor Ni connected between the low voltage terminal VL and the output terminal Yi, and a body diode may be formed with the respective transistors Pi and Ni. In such embodiments, a voltage of the high voltage terminal VH may be output to the output terminal Yi when the transistor Pi is turned on. The transistor Pi may be turned on when the input data signal DATA has a low level. A voltage of the low voltage terminal VL may be output to the output terminal Yi when the transistor Ni is turned on. The transistor Ni may be turned on when the input data signal DATA has a high level.

Referring still to FIG. 2, an anode of the diode DscH may be connected to a power source VscH for supplying a VscH voltage, and a cathode of the diode DscH may be connected to the high voltage terminal VH of the scan ICs 431, 432.

A first terminal of the capacitor Csc may be connected to the high voltage terminal VH of the scan ICs 431, 432, and a second terminal of the capacitor Csc may be connected to the transistor YscL (FIG. 2). When the transistor YscL is turned on, a voltage of (VscH−VscL) may be charged in the capacitor Csc. The transistor YscL may be connected between a power source VscL for supplying a VscL voltage and the low voltage terminal VL of the scan ICs 431, 432.

When only a scan operation is performed with respect to the first group Yodd, during the scan operation, the scan IC 431 may sequentially apply a voltage of the low voltage terminal VL to the Y electrodes Y1, Y3, . . . , Yn−1, and may apply a voltage of the high voltage terminal VH to the Y electrode(s) of the first group Yodd to which the voltage of the low voltage terminal VL is not being applied. During this time, the scan IC 432 may apply the voltage of the high voltage terminal VH to the Y electrodes Y2, Y4, . . . , Yn of the second group Yeven.

When a scan operation is performed with respect to the second group Yeven, the scan IC 432 may sequentially apply the voltage of the low voltage terminal VL to the Y electrodes Y2, Y4, . . . , Yn of the second group Yeven, and may apply the voltage of the high voltage terminal VH to the Y electrodes to which the voltage of the low voltage terminal VL is not being applied. During this time, the scan IC 431 may apply the voltage of the high voltage terminal VH to the Y electrodes Y1, Y3, . . . , Yn−1 of the first group Yodd.

The control signals OC2 and OC1_odd and OC1_even, respectively, may control operations of the scan ICs 431 and 432. Exemplary operations of the scan ICs 431, 432 may be determined by levels of the control signals OC1_odd and OC1_even, respectively, and OC2, as shown in in Table 1 below. Table 1 also shows functions of the scan ICs 431 and 432. In Table 1, H denotes a high level, L denotes a low level, and X denotes no relation to levels. In addition, for the data signal DATA, L and H respectively denote a low level pulse and a high level pulse, respectively corresponding to pulse widths of the scan voltage to be applied to the corresponding group of Y electrodes. More particularly, in such embodiments, e.g., when the control signals OC1_odd and OC1_even are at the low levels L and the control signal OC2 is at the high level H, the scan ICs 431, 432 may sequentially shift the data signal DATA and transmit a pulse corresponding to the data signal DATA to the pairs of transistors 431a. For example, a pulse corresponding to the data signal DATA may have a same level and width as the data signal DATA. Thereby, when the data signal DATA is the low level L, the PMOS transistor Pi among the pair of transistors 431a may be turned on, and the voltage of the high voltage terminal VH may be output during a period corresponding to the pulse width of the data signal DATA. When the data signal DATA is the high level H, the NMOS transistor Ni among the pair of transistors 431a may be turned on, and the voltage of the low voltage terminal VL may be output during a period corresponding to the pulse width of the data signal DATA.

TABLE 1

| | OC1_odd/ | | |
|---|---|---|---|
| DATA | OC1_even | OC2 | Output |
| L | L | H | A voltage of a high voltage terminal VH is |
| | | | sequentially output. |
| H | L | H | A voltage of a low voltage terminal VL is |
| | | | sequentially output. |
| X | H | H | Every output terminal outputs a voltage of |
| | | | a high voltage terminal VH. |
| X | H | L | Every output terminal outputs a voltage of |
| | | | a low voltage terminal VL. |

In such exemplary embodiments, as described above, when the scan operation is performed with respect to the first group Yodd, the control signal OC1_odd of the first group Yodd may be set to be the low level L and the control signal OC1_even of the second group Yeven may be set to be the high level H, as shown in exemplary Table 2 below. Thereby, the control signal OC2 may be set to the high level by the NAND gate 433, the scan IC 431 may sequentially output the voltage of the low voltage terminal VL to the Y electrodes of the first group Yodd, and the scan IC 432 may output the voltage of the high voltage terminal VH to the Y electrodes of the second group Yeven.

In a like manner, when the scan operation is performed with respect to the second group Yeven, the control signal OC1_odd of the first group Yodd may be set to be the high level H, and the control signal OC1-even of the second group Yeven may be set to be the low level L. Thereby, the control signal OC2 may be set to the high level L by the NAND gate 433, the scan IC 431 may output the voltage of the high voltage terminal VH to the Y electrodes of the first group Yodd, and the scan IC 432 may sequentially output the voltage of the low voltage terminal VL to the Y electrodes of the second group Yeven.

When a reset operation is performed for the first and second groups Yodd and Yeven, the control signals OC1_odd and OC1_even of the first group Yodd and the second group Yeven, respectively, may be set to be low levels L while the data signal DATA is maintained to be the low level L. Thereby, the control signal OC2 may be set to the high level H by the NAND gate 433. Therefore, the scan ICs 431, 432 may output the voltage of the high voltage terminal VH through all the output terminals thereof.

When a sustain discharge operation is performed for the first and second groups Yodd and Yeven, the control signals OC1_odd and OC1_even of the first and second groups may be set to be the high level H. Thereby, the control signal OC2 may be set to the low level L by the NAND gate 433, and therefore the scan ICs 431, 432 may output the voltage of the low voltage terminal VL through all the output terminals thereof. That is, under such conditions, in the exemplary embodiment described above, the scan ICs 431, 432 may out the voltage of the low voltage terminal VL to all the Y electrodes of the respective Y electrode group Yodd, Yeven.

TABLE 2

| DATA | OC1_odd | OC1_even | OC2 | Output |
|---|---|---|---|---|
| H | L | H | H | A voltage of a low voltage terminal |
| | | | | VL is sequentially output to Y |
| | | | | electrodes of the first group. |
| H | H | L | H | A voltage of a low voltage terminal |
| | | | | VL is sequentially output to Y |
| | | | | electrodes of the second group. |
| L | L | L | H | All output terminals output a |
| (maintenance) | | | | voltage of a high voltage terminal |
| | | | | VH. |
| X | H | H | L | All output terminals output a |
| | | | | voltage of a low voltage terminal |
| | | | | VL. |

Referring to FIG. 2, the reset driver 410 and the sustain driver 420 may be connected to the low voltage terminal VL of the scan ICs 431, 432. During a reset period of each subfield, the reset driver 410 may apply a reset waveform to the plurality of Y electrodes, Yodd and Yeven, respectively, through the low voltage terminal VL of the scan ICs 431, 432. More particularly, e.g., in such embodiments, the reset driver 410 may apply the reset waveform to the plurality of Y electrodes, Yodd and Yeven, respectively, through the high voltage terminal VH of the scan ICs 431, 432 during a rising period of the reset period of each subfield. The sustain driver 420 may apply a sustain pulse to the Y electrodes, Yodd and Yeven, respectively, through the low voltage terminal VL of the scan ICs 431, 432 during the sustain period of each subfield.

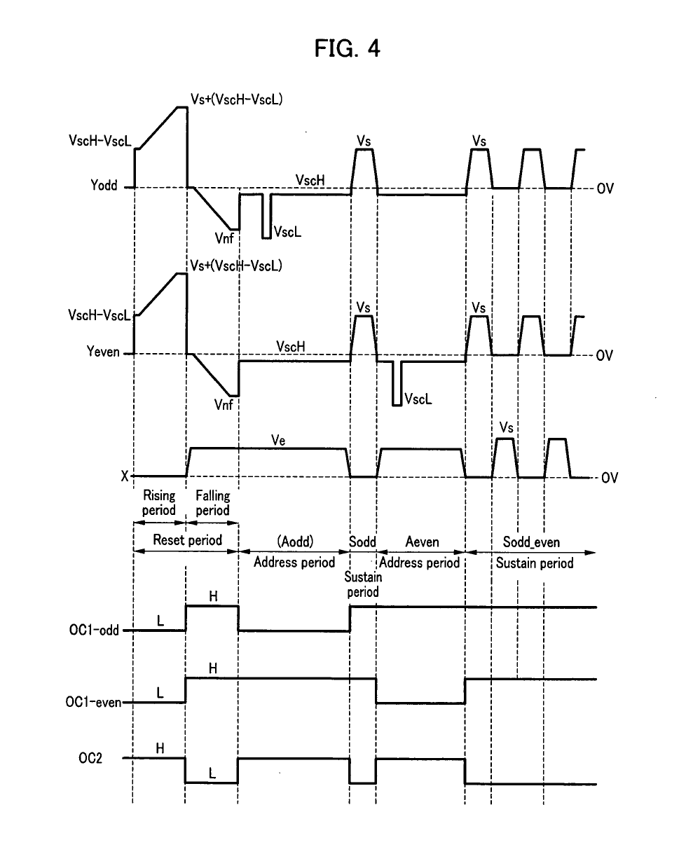

Exemplary driving waveforms employable by the plasma display device according to the first exemplary embodiment of the present invention will now be described with reference to FIG. 4.

FIG. 4 illustrates a diagram of exemplary driving waveforms employable to drive a plasma display device, e.g., the plasma display device shown in FIG. 1, according to a first exemplary embodiment of the present invention.

In FIG. 4, for convenience of description, only driving waveforms applied to one X electrode and two Y electrodes are illustrated. In embodiments, except for address periods, e.g., Aodd and Aeven, the same waveforms may be applied to the Y electrodes Y1 to Yn of the first and second groups Yodd and Yeven.

Referring to FIGS. 1 and 4, during the rising period of the reset period, the sustain electrode driver 500 may apply a reference voltage, e.g., 0V, to the X electrodes X1 to Xn, and the scan electrode driver 400 may gradually increase a voltage of the plurality of Y electrodes Y1 to Yn from a voltage of (VscH−VscL) to a voltage of (Vs+(VscH−VscL)). Thereby, while a voltage of the respective Y electrode increases, a weak reset discharge may be generated between the respective Y electrode and the corresponding X electrode. Thus, wall charges may be formed at the plurality of corresponding discharge cells 110. Accordingly, during the rising period of the reset period, the controller 200 may set control signals OC1_odd and OC1_even to be at the low level L, and the data signal DATA may be maintained at the low level L. Referring to FIGS. 2 and 4, the control signal OC2 may be established to be the high level H by the NAND gate 433, and may be applied to the scan ICs 431, 432. The reset driver 410 may gradually increase the voltage of the low voltage terminal VL from the reference voltage, e.g., 0V voltage to a Vs voltage. Therefore, the voltage of the high voltage terminal VH may be gradually increased from the voltage of (VscH−VscL) to the voltage of (Vs+(VscH−VscL)) by the capacitor Csc. Thereby, a ramp voltage increasing from the voltage of (VscH−VscL) to the voltage of (Vs+(VscH−VscL)) may be applied to the Y electrodes Y1 to Yn of the first and second groups Yodd and Yeven through the high voltage terminal VH of the scan ICs 431, 432.

Referring to FIGS. 1 and 4, subsequently, during a falling period of the reset period, the sustain electrode driver 500 may apply a Ve voltage to the X electrodes X1 to Xn, and the reset driver 410 may gradually decrease a voltage of the Y electrodes Y1 to Yn from the reference voltage, e.g., 0V voltage, to a Vnf voltage. Thereby, while the voltage of the Y electrode decreases, a weak discharge may be generated between corresponding ones of the Y electrode and the X electrode. In addition, wall charges that may be formed at the plurality of corresponding discharge cells 110 may be eliminated such that the corresponding discharge cells 110 may be initialized as non-light emitting cells. Therefore, during the falling period of the reset period, the controller 200 may set the control signals OC1_odd and OC1_even to be the high level L. Further, the control signal OC2 may be set to be the low level L by the NAND gate 433 and may be applied to the scan ICs 431 and 432, as discussed above.

Further, the reset driver 410 may gradually decrease the voltage of the low voltage terminal VL from the reference voltage, e.g., 0V, to the Vnf voltage. Therefore, a voltage of the low voltage terminal VL of the scan ICs 431, 432 may be gradually decreased from the reference voltage 0V to the Vnf voltage. Thereby, a voltage decreasing from the reference voltage 0V to the Vnf voltage may be applied to the Y electrodes Y1 to Yn of the first and second groups Yodd and Yeven through the low voltage terminal VL of the scan ICs 431, 432, respectively.

Referring to FIG. 4, during the address period Aodd, the sustain electrode driver 500 may apply the Ve voltage to the X electrodes X1 to Xn, and the scan driver 430 may turn on the transistor YscL (FIG. 2) to sequentially apply a scan pulse having the VscL voltage to the Y electrodes Y1, Y3, . . . , Yn−1 of the first group Yodd. The address electrode driver 300 may apply an address pulse having a positive voltage (not shown) to the A electrode of light emitting discharge cells among the respective discharge cells 110 defined by the Y electrodes of the first group Yodd to which the scan pulse is applied. Thereby, an address discharge may be generated in the selected cell(s) to which the VscL voltage of the scan pulse and the positive voltage of the address pulse are applied, a wall voltage may be formed at the respective X electrode and the respective Y electrode of the first group Yodd, and the respective cell(s) 110 may emit light. During the address period Aodd, the controller 200 may set the control signal OC1_odd to be at the low level L, the control signal OC1_even to be at the high level H, and the data signal DATA (not shown) to be at the high level H. The control signal OC2, which may be applied to the scan ICs 431, 432, may be set to be at the high level by the NAND gate 433. The scan driver 430 may apply the VscL voltage to the low voltage terminal VL and may apply the VscH voltage to the high voltage terminal VH of the scan ICs 431, 432. Thereby, the scan pulse having the VscL voltage may be sequentially applied to the Y electrodes Y1, Y3, . . . , Yn−1 of the first group Yodd through the low voltage terminal VL of the scan IC 431. Through the high voltage terminal VH of the scan IC 431, the VscH voltage that is higher than the VscL voltage may be applied to the Y electrode(s) of the first group Yodd to which the VscL voltage is not applied. The VscH voltage may be applied to the Y electrodes Y2, Y4, . . . , Yn of the second group Yeven through the high voltage terminal VH of the scan IC 432.

During the sustain period Sodd, e.g., sustain period after the address period of the first group of Y electrodes Yodd, the sustain driver 420 may apply the Vs voltage to the Y electrodes Y1 to Yn of the first and second groups Yodd and Yeven. The sustain electrode driver 500 may apply the reference 0V voltage to the X electrodes X1 to Xn. Thereby, a sustain discharge may be generated in the discharge cell(s) 110 in which the address discharge is generated during the address period Aodd. Accordingly, negative (−) wall charges may be formed at the Y electrodes Y1, Y3, . . . , Yn−1 of the first group Yodd and positive (+) wall charges may be formed at the X electrode. Referring to FIG. 4, the sustain discharge may be generated once during the sustain period Sodd. During the sustain period Sodd, the controller 200 may set the control signals OC1_odd and OC1_even, which may be applied to the scan ICs 431, 432, to be at high levels H. The control signal OC2, which may be applied to the scan ICs 431, 432, may be established to be the low level L. The sustain driver 420 may alternately apply the Vs voltage and the reference voltage 0V to the low voltage terminal VL. Thereby, the Vs voltage may be applied to the Y electrodes Y1 to Yn of the first and second groups Yodd and Yeven through the respective low voltage terminals VL of the scan ICs 431, 432.

During the address period Aeven, the sustain electrode driver 500 may apply the Ve voltage to the X electrodes X1 to Xn, and the scan electrode driver 400 may turn on the transistor YscL (FIG. 2) to sequentially apply the scan pulse having the VscL voltage to the Y electrodes Y2, Y4, . . . , Yn of the second group Yeven. The address electrode driver 300 may apply the address pulse having the positive voltage (not shown) to the A electrode of the light emitting discharge cell(s) among the respective discharge cells 110 defined by the Y electrodes of the second group Yeven to which the scan pulse is applied. Thereby, address discharge may be generated in the respective cell(s) to which the scan pulse of the VscL voltage and the positive voltage of the address pulse are applied, a wall voltage may be formed at the respective selected ones of the X electrode and the respective Y electrode of the second group Yeven, and the respective cell(s) 110 may emit light. During the address period Aeven, the controller 200 may set the control signal OC1_odd to be at the high level H, the control signal OC1_even to be the low level L, and the data signal DATA (not shown) to be the high level H. The control signal OC2, which may be applied to the scan ICs 431, 432, may be set to be at the high level H. The scan driver 430 may apply the VscL voltage to the low voltage terminal VL, and the VscH voltage to the high voltage terminal VH of the scan ICs 431, 432. Thereby, the VscH voltage may be applied to the Y electrodes Y1, Y3, . . . , Yn−1 of the first group Yodd through the high voltage terminal VH of the scan IC 431. The scan pulse having the VscL voltage may be sequentially applied to the Y electrodes Y2, Y4, . . . , Yn of the second group Yeven through the low voltage terminal VL of the scan IC 432. Through the high voltage terminal VH of the scan IC 432, the VscH voltage may be applied to the Y electrode(s) of the second group Yeven to which the VscL voltage is not applied.

Subsequently, during the sustain period Sodd_even, the sustain driver 420 may, e.g., apply the Vs voltage to the Y electrodes Y1 to Yn of the first and second groups Yodd and Yeven, and the sustain electrode driver 500 may apply the reference voltage 0V to the X electrodes X1 to Xn. Thereby, sustain discharge may be generated in the respective discharge cell(s) 110 in which address discharge is generated during the address period Aeven. Therefore, negative (−) wall charges may be accumulated at the Y electrodes Y2, Y4, . . . , Yn of the second group Yeven, and positive (+) wall charges may be accumulated at the X electrode(s). Subsequently, e.g., the scan electrode driver 400 may apply the reference voltage 0V to the Y electrodes Y1 to Yn of the first and second groups Yodd and Yeven, and the sustain electrode driver 500 may apply the Vs voltage to the X electrodes X1 to Xn. Thereby, sustain discharge may be generated between the respective selected ones of the Y electrodes Y1 to Yn and the X electrodes X1 to Xn. Therefore, positive (+) wall charges may be accumulated at the Y electrodes Y1 to Yn, and negative (−) wall charges may be accumulated at the corresponding X electrode. Subsequently, during the sustain period Sodd-even, the sustain pulse may be alternately applied to the Y electrodes Y1 to Yn and the X electrodes X1 to Xn, and the number of applied sustain pulses may vary according to a weight value of a corresponding subfield.

During the sustain period Sodd-even, the controller 200 may set the control signals OC1_odd and OC1_even to be at the high level H. The control signal OC2, which may be applied to the scan ICs 431, 432, may be set to be at the low level L by the NAND gate 433. In addition, the sustain driver 420 may alternately apply the Vs voltage and the reference voltage 0V to the low voltage terminal VL. Thereby, through each low voltage terminal VL of the scan ICs 431, 432, the Vs voltage and the reference voltage 0V may be alternately applied to the Y electrodes Y1 to Yn of the first and second groups Yodd and Yeven.

As described, in the exemplary embodiment of the present invention, because the control signal OC2 may be generated by the control signals OC1_odd and OC1_even output from the controller 200, an erroneous operation of the scan ICs 431 and 432 by delays of the control signal OC2 and the control signals OC1_odd and OC1_even may be prevented and/or reduced. Separately, because the controller 200 may not be required to generate the control signal OC2, the controller 200 may be more simply designed.

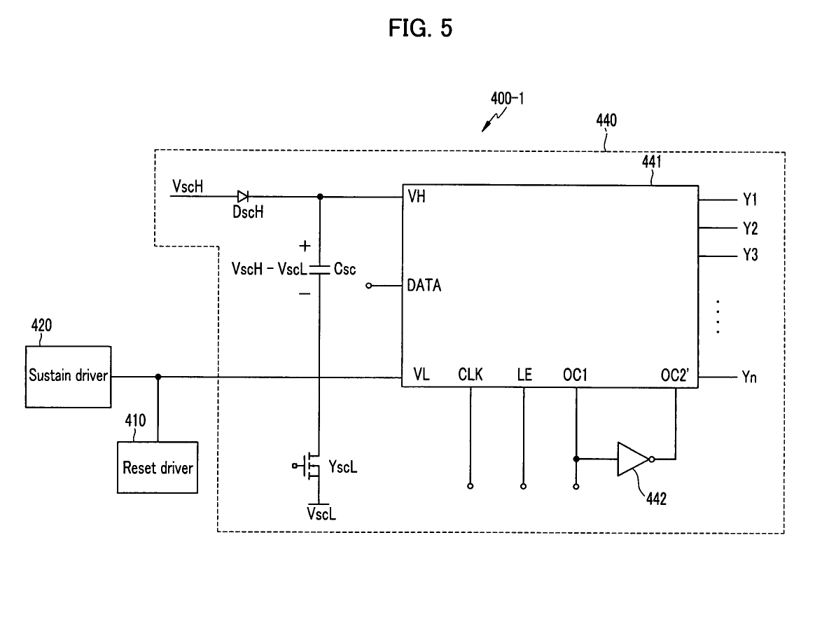

FIG. 5 illustrates a schematic diagram of another exemplary embodiment of a scan electrode driver 400-1 according to a second exemplary embodiment of the present invention.

As shown in FIG. 5, the scan electrode driver 400-1 may include a reset driver 410, a sustain driver 420, and a scan driver 440. The scan driver 440 may include a scan IC 441, a capacitor Csc, a diode DscH, a transistor YscL, and an inverter 442.

Differing from the scan electrode driver 400 according to the first exemplary embodiment illustrated in FIG. 2, the scan electrode driver 400-1 according to the second exemplary embodiment does not group the Y electrodes, but may sequentially drive the Y electrodes, e.g., from the Y1 electrode to the Yn electrode. That is, the scan IC 441 may be connected to the plurality of Y electrodes Y1 to Yn. In embodiments, when a number of output terminals of the scan IC 441 is less than the number of Y electrodes Y1 to Yn, a plurality of scan ICs may be used. In such embodiments, the inverter 442 of the scan electrode driver 400-1 may perform a NAND operation on the first control signal OC1 input from the controller 200 to generate a second control signal OC2′. In such embodiments, as shown in Table 3 below, an operation of the scan IC 441 may be determined by the two control signals OC1 and OC2′, and the second control signal OC2′ may be generated by inverting the first control signal OC1 by the inverter 442. The scan IC 441 may be driven by two control signals OC1 and OC2′ as shown in Table 3.

TABLE 3

| DATA | OC1 | OC2′ | Output |
|---|---|---|---|
| L | L | H | All output terminals output the voltage of |
| (maintenance) | | | the high voltage terminal VH. |
| H | L | H | Sequentially output the voltage of the |
| | | | low voltage terminal VL. |
| X | H | L | All output terminals output the voltage |
| | | | of the low voltage terminal VL. |

When a scan operation is performed as shown in Table 3, the controller 200 may set the data signal DATA to be at the high level H, and the first control signal OC1 to be at the low level L. Under such circumstances, because a level of the second control signal OC2′ becomes the high level H by the inverter 442, the scan IC 441 may sequentially output a voltage of the low voltage terminal VL. When a reset operation is performed, the controller 200 may set the first control signal OC1 to be at the low level L while maintaining the data signal DATA at the low level L. Under such circumstances, because a level of the second control signal OC2′ becomes the high level H, all the output terminals of the scan IC 441 may output a voltage of the high voltage terminal VH. In such cases, states of the first and second control signals OC1 and OC2′ may be the same as the states of when the scan operation is performed. However, when the data signal DATA is maintained to be input at the low level L, the PMOS transistor Pi (FIG. 3) connected to the high voltage terminal VH among the pairs of transistors 431a (FIG. 3) of all the output terminals of the scan IC 441 may be turned on, and all the output terminals may output a voltage of the high voltage terminal VH. When a sustain discharge is performed, the controller 200 may set the first control signal OC1 to be at the high level H. Under such circumstances, because a level of the second control signal OC2′ becomes the low level L, the scan IC 441 may output a voltage of the low voltage terminal VL through all the output terminals regardless of the data signal DATA.

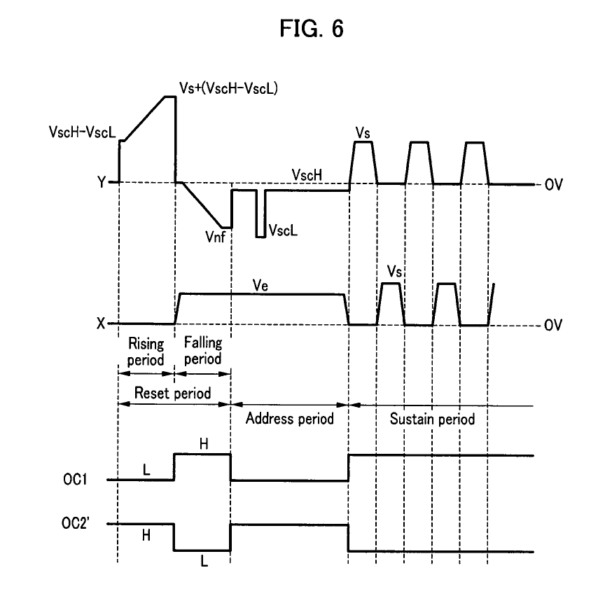

Referring to FIG. 6, exemplary driving waveforms employable by a plasma display device according to the second exemplary embodiment of the present invention will be described below.

FIG. 6 illustrates a diagram of exemplary driving waveforms employable to drive a plasma display, e.g., the plasma display device shown in FIG. 1, according to the second exemplary embodiment of the present invention. For better understanding and ease of description, only driving waveforms applied to one X electrode and one Y electrode are illustrated in FIG. 6.

Referring to FIG. 6, during a rising period of a reset period, the sustain electrode driver 500 may apply the reference voltage 0V to the X electrode, and the scan electrode driver 400 may gradually increase a voltage of the Y electrode from the voltage of (VscH−VscL) to the voltage of (Vs+(VscH−VscL)). Thereby, while a voltage of the Y electrode may increase, a weak reset discharge may be generated between the respective Y electrode and the respective X electrode. Wall charges may be formed at respective ones of the plurality of discharge cells 1 10. Therefore, during the rising period of the reset period, the controller 200 may set the first control signal OC1 to be at the low level L, and may maintain the data signal DATA to be at the low level L. The second control signal OC2′, which may be applied to the scan IC 441, may be set to be at the high level H by the inverter 442. The reset driver 410 may gradually increase a voltage of the low voltage terminal VL from the reference voltage 0V to the Vs voltage. Therefore, a voltage of the high voltage terminal VH may be gradually increased from the voltage of (VscH−VscL) to the voltage of (Vs+(VscH−VscL)) by the capacitor Csc. Thereby, a voltage increasing from the voltage of (VscH−VscL) to the voltage of (Vs+(VscH−VscL)) may be applied to the Y electrode through the high voltage terminal VH of the scan IC 441.

Subsequently, during a falling period of the reset period, the sustain electrode driver 500 may apply the Ve voltage to the X electrode and may gradually decrease a voltage of the Y electrode of the reset driver 410 from the reference voltage 0V to the Vnf voltage. Thereby, while a voltage of the Y electrode decreases, a weak reset discharge may be generated between the respective Y electrode and the X electrode. Wall charges formed at the discharge cell(s) 110 may be eliminated and the discharge cell(s) 110 may be initialized as non-light emitting cells. Therefore, during the falling period of the reset period, the controller 200 may set the first control signal OC1 to be at the high level H. The second control signal OC2′ may be set at the low level L by the inverter 442 to be applied to the scan IC 441. The reset driver 410 may gradually decrease a voltage of the low voltage terminal VL from the reference voltage 0V to the Vnf voltage. Therefore, a voltage of low voltage terminal VL may be gradually decreased from the reference voltage 0V to the Vnf voltage. Thereby, a voltage decreasing from the reference voltage 0V to the Vnf voltage may be applied to the Y electrode through the low voltage terminal VL of the scan IC 441.

During an address period, the sustain electrode driver 500 may apply the Ve voltage to the plurality of X electrodes, and the scan driver 440-1 may turn on the transistor YscL (FIG. 5) to sequentially apply a scan pulse having the VscL voltage to the respective Y electrode. In this case, the address electrode driver 300 may apply an address pulse having a positive voltage (not shown) to the A electrode of the respective light emitting cell(s) among the discharge cells 110 defined by the Y electrode to which the scan pulse is applied. Thereby, address discharge may be generated in the selected discharge cells to which the VscL voltage of the scan pulse and the positive voltage of the address pulse are applied, a wall voltage may be formed at the respective X electrode and the respective Y electrode, and the respective discharge cell(s) 110 may emit light. During the address period, the controller 200 may set the first control signal OC1 to be at the low level L, and may set the data signal DATA (not shown) to be at the high level H. In addition, the second control signal OC2′, which may be applied to the scan IC 441, may be set to be at the high level by the inverter 442. The scan driver 440 may apply the VscL voltage to the low voltage terminal VL and may apply the VscH voltage to the high voltage terminal VH. Thereby, the scan pulse having the VscL voltage may be sequentially applied to the respective Y electrode through the low voltage terminal VL of the scan IC 441. The VscH voltage may be applied to the Y electrode to which the VscL voltage is not applied through the high voltage terminal VH of the scan IC 441.

During a sustain period, the sustain driver 420 may apply the sustain pulse having the Vs voltage to the Y electrode. The sustain electrode driver 500 may apply the reference voltage 0V to the X electrode. Thereby, during the address period, sustain discharge may be generated in the respective discharge cell(s) 110 in which address discharge is generated. Therefore, negative (−) wall charges may be accumulated at the respective Y electrode, and positive (+) wall charges may be accumulated at the respective X electrode. Subsequently, the scan electrode driver 400 may apply the reference voltage 0V voltage to the respective Y electrode, and the sustain electrode driver 500 may apply the sustain pulse to the respective X electrode. Thereby, the sustain discharge may be generated between the respective X electrode and the respective Y electrode. A number of sustain pulses applied to the respective electrodes during the respective sustain period may vary according to a weight value of a corresponding subfield. During the sustain period, the controller 200 may set the first control signal OC1 to be at the high level H. The second control signal OC2′, which may be applied to the scan IC 441, may be set to be at the low level by the inverter 442. The sustain driver 420 may alternately apply the Vs voltage and the reference voltage 0V to the low voltage terminal VL. Thereby, the Vs voltage and the reference voltage 0V may be alternately applied to the respective Y electrode through the low voltage terminal VL of the scan IC 441.

In the second exemplary embodiment of the present invention, because the second control signal OC2′ is generated by the first control signal OC1 output from the controller 200, as shown in FIG. 1, erroneous operation of the scan IC 441 by delays of the second control signal OC2′ and the first control signal OC1 may be prevented and/or reduced. In addition, because the controller 200 is not required to generate the second control signal OC2′, the controller 200 may be more simply designed.

Exemplary embodiments of aspects of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A scan electrode driver employable to drive a plurality of scan electrodes of a plasma display device and to receive a control signal, the scan electrode driver comprising:
at least one scan integrated circuit including:
a first control signal input terminal,
a second control signal input terminal,
a data input terminal,
a first voltage terminal,
a second voltage terminal, and
a plurality of output terminals respectively connected to the plurality of scan electrodes; and
a logic element adapted to perform an operation on the control signal to generate a second control signal to be applied to the second control signal input terminal,
wherein:
the scan integrated circuit is adapted to establish a voltage of the plurality of output terminals to be a voltage of the first voltage terminal or a voltage of the second voltage terminal at least based on a level of the control signal transmitted to the first control signal input terminal thereof, and
the control signal and the second control signal have a first level or a second level.

2. The scan electrode driver as claimed in claim 1, wherein the logic element is an inverter.

3. The scan electrode driver as claimed in claim 1, wherein:
when the control signal is at the first level and the scan integrated circuit receives a first data pulse of a third level at the data input terminal thereof,
the scan integrated circuit is adapted to sequentially output the voltage of the second voltage terminal to selected ones of the plurality of scan electrodes based on the first data pulse and to output the voltage of the first voltage terminal to the ones of the plurality of scan electrodes to which the voltage of the second voltage terminal is not applied.

4. The scan electrode driver as claimed in claim 3, wherein:
when the control signal is at the first level and the scan integrated circuit receives a second data pulse of a fourth level at the data input terminal thereof,
the scan integrated circuit is adapted to output the voltage of the first voltage terminal to the plurality of scan electrodes.

5. The scan electrode driver as claimed in claim 3, wherein:
when the control signal is at the second level, the scan integrated circuit is adapted to output a voltage of the second voltage terminal to the plurality of scan electrodes.

6. The scan electrode driver as claimed in claim 1, wherein the scan electrode driver includes only one scan integrated circuit.

7. The scan electrode driver as claimed in claim 1, wherein:
the at least one scan integrated circuit includes a first scan integrated circuit and a second scan integrated circuit and the control signal includes a first control signal and a third control signal,
the first scan integrated circuit is adapted to receive the first control signal as at the first control signal input terminal thereof, and
the second scan integrated circuit is adapted to receive the third control signal at the first control signal input terminal thereof, the first, second and third control signals have the first level or the second level.

8. The scan electrode driver as claimed in claim 7, wherein:
the logic element is adapted to perform an operation on the first control signal and the third control signal to generate the second control signal,
output terminals of the first scan electrode driver are respectively connected to respective ones of the plurality of scan electrodes belonging to a first group of scan electrodes,
output terminals of the second scan electrode driver are respectively connected to respective ones of the plurality of scan electrodes belonging to a second group of scan electrodes,
the first scan integrated circuit is adapted to apply the voltage of the first voltage terminal or the voltage of the second voltage terminal to the scan electrodes of the first group based on a level of at least one of the first control signal and the second control signal, and
the second scan integrated circuit is adapted to apply the voltage of the first voltage terminal of the voltage of the second voltage terminal to the scan electrodes of the second group based on a level of at least one of the third control signal and the second control signal.

9. The scan electrode driver as claimed in claim 8, wherein the logic element is a NAND gate.

10. The scan electrode driver as claimed in claim 8, wherein the second control signal is at the second level when the first and third control signals are at the first level, the second control signal is at the second level when one of the first and third control signals is at the first level and the other of the first and third control signals is at the second level, and the second control signal is at the first level when the first and third control signals are at the second level.

11. The scan electrode driver as claimed in claim 8, wherein:
when the first control signal is at the first level, the third control signal is at the second level and the first scan integrated circuit receives a first data pulse of a third level at the data input terminal thereof,
the first scan integrated circuit is adapted to sequentially output the voltage of the second voltage terminal to the plurality of scan electrodes of the first group based on the first data pulse, and
the second scan integrated circuit is adapted to output the voltage of the first voltage terminal to the plurality of scan electrodes of the second group.

12. The scan electrode driver as claimed in claim 8, wherein:
when the first control signal is at the second level, the third control signal is at the first level and the second scan integrated circuit receives a second data pulse of a third level at the data input terminal thereof,
the second scan integrated circuit is adapted to sequentially output the voltage of the second voltage terminal to the plurality of scan electrodes of the second group based on the second data pulse, and
the first scan integrated circuit is adapted to output the voltage of the first voltage terminal to the plurality of scan electrodes of the first group.

13. The scan electrode driver as claimed in claim 8, wherein:
when the first control signal is at the first level, the third control signal is at the first level, the first scan integrated circuit receives a third data pulse of a fourth level at the data input terminal thereof, and the second scan integrated circuit receives the third data pulse of the fourth level,
the first scan integrated circuit is adapted to output the voltage of the first voltage terminal to the plurality of scan electrodes of the first group, and
the second scan integrated circuit is adapted to output the voltage of the first voltage terminal to the plurality of scan electrodes of the second group.

14. The scan electrode driver as claimed in claim 13, wherein:
when the first control signal is at the second level and the third control signal is at the second level,
the first scan integrated circuit is adapted to output the voltage of the second voltage to the plurality of scan electrodes of the first group, and
the second scan integrated circuit is adapted to output the voltage of the second voltage terminal to the plurality of scan electrodes of the second group.

15. The scan electrode driver as claimed in claim 1, wherein the first level is a low level, and the second level is a high level.

16. A driving method for a plurality of scan electrodes of a plasma display device using a scan electrode driver including at least one scan integrated circuit adapted to transmit a voltage to the plurality of scan electrodes, the driving method comprising:
transmitting a control signal to the scan integrated circuit;
generating a second control signal based on the control signal; and
transmitting, from the scan integrated circuit, a voltage to the plurality of scan electrodes based on the control signal and the second control signal.

17. The driving method as claimed in claim 16, wherein generating the second control signal includes generating the second control signal by performing a logic operation, the control signal being input to the logic operation.

18. The driving method as claimed in claim 17, wherein the logic operation is one of an inversion operation or a NAND operation.

19. The driving method as claimed in claim 16, wherein the at least one scan integrated circuit includes a first scan integrated circuit adapted to transmit a voltage to respective ones of the plurality of scan electrodes belonging to a first group and a second scan integrated circuit adapted to transmit a voltage to respective ones of the plurality of scan electrodes belonging to a second group, and the control signal includes a first control signal and a third control signal, wherein:
transmitting includes:
transmitting the first control signal to the first scan integrated circuit, and
transmitting the third control signal to the second scan integrated circuit, and
generating includes:
generating, within the scan electrode driver, the second control signal based on the first control signal and the third control signal.

20. The driving method as claimed in claim 19, wherein generating includes generating the second control signal using a NAND operation, the first control signal and the third control signal being input to the NAND operation.
